(19) United States
(12) Patent Application Publication
(10) Pub. No.: US 2007/0285489 A1
(43) Pub. Date: Dec. 13, 2007

(54) LABEL DEVICE FOR OPTICAL DISC

(76) Inventors: Peng Chen, Taipei City (TW); Fung-Hsu Wu, Gueishan Township (TW); Bow-Yi Jang, Taichung City (TW); Lin Hsiao, Taoyuan City (TW)

Correspondence Address: HOFFMAN WARNICK & D'ALESSANDRO, LLC, 75 STATE STREET, 14TH FLOOR, ALBANY, NY, 12207, US

(21) Appl. No.: 11/422,938

(22) Filed: Jun. 8, 2006

(51) Int. Cl. B41J 2/435; G01D 15/14

(52) U.S. Cl. 347/224

(57) ABSTRACT

The present invention relates to a label device for optical discs, which is capable of being installed into an optical disc device to form an image thereon. The label device includes a label layer and an adhesive. The label layer has a bottom surface on which the adhesive is formed. The label layer is configured to form the image via a writing unit. The label layer further includes a substrate and a label film for forming the image thereon. The label device is attached to a base or an optical disc by the adhesive so as to be installed into the optical disc device. The optical disc device is then utilized to form the image on the label film.

### BACKGROUND OF THE INVENTION

1. Field of the Invention

The present invention relates generally to labels for optical discs and, more particularly, to a label device capable of being installed into an optical disc device to form an image thereon.

2. Description of the Prior Art

Optical discs are a highly popular medium for storing data in various forms such as text, graphics, audio, video . . . etc. Examples of available optical disc formats include CD-R, CD-RW, DVD-R, DVD-RW . . . , etc. When optical disc technology was first introduced, only source manufacturers could program individual optical discs, and they typically did so on a mass production basis. Once formatted with the desired data, the optical discs were provided to consumers with some form of printed identification information on a non-data surface thereof. Because the optical discs were mass produced, it was economically feasible, from a marketing standpoint, and highly desirable to imprint stylized identification information onto the optical disc's surface. While this practice is still being followed today, more recently, consumers have been able to “burn” their own optical discs. In other words, it is now possible for a consumer to record desired data onto an otherwise “blank” optical disc. Once formatted, the user will almost certainly desire to provide some form of identification information on the non-data surface of the optical disc. Unlike mass-produced optical discs programmed by optical disc manufacturers, the average consumer cannot imprint identification information onto the optical disc's non-data surface. Instead, consumers typically make use of a separately provided label.

In general terms, optical disc labels are formed from paperstock, which has an adhesive backing for attaching to a top surface of the optical disc. The paperstock is normally white, and it also provides a surface onto which the user can hand write identification information with a writing utensil such as a pen or marker. More recently, computer programs have been developed that allow users to independently create highly stylized, professional-quality designs formatted for printing on a corresponding optical disc label. To this end, the label is provided as part of a label sheet that is sized to be used with a printer, such as an inkjet printer. The user simply loads the label sheet into the printer, operates a linked computer to create the desired labeling design or image, and then instructs the printer to print the so-created design or image onto the label.

In recent years, there has been a proposed technology related to creating images on the label layer of an optical disc, as disclosed in U.S. Pat. No. 6,864,907 obtained by Hewlett-Packard Development Company, L.P.; the technology is also known as the LightScribe technology, in which a coloring layer that changes its color in response to heat or light is integrally provided with an optical disc. The coloring layer is provided on a label face opposite to the recording face to draw images in order to indicate the contents recorded on the optical disc. The label face is set to face an optical pickup, and a laser beam is radiated by the optical pickup to cause the coloring layer to change its color, so as to form a visible image. A group of alignment marks are pre-printed on the label layer in order to position the images to be printed. Before printing images onto the label layer, the optical disc has to be flipped in order to have the label layer face the optical pickup.

The main limitation of LightScribe technology is that it only applies to optical discs that are manufactured through special processing. However, consumers continue to demand high quality yet inexpensive labels for labeling optical discs that do not support LightScribe features. Accordingly, one objective of the present invention is to provide a label device, which is capable of being installed into an optical disc device to form an image thereon and being further applied to general-purpose optical discs.

### SUMMARY OF THE INVENTION

The present invention pertains to a label device for optical discs. Particularly, the label device, according to the invention, is capable of being installed into an optical disc device to form an image thereon. The optical disc device includes a writing unit. According to a first preferred embodiment of the invention, the label device includes a label layer and an adhesive. The label layer has a bottom surface on which the adhesive is formed. The label layer is configured to form the image via the writing unit. The label layer further includes a substrate and a label film for forming the image thereon. The label device is attached to a base or an optical disc by the adhesive, so as to be installed in the optical disc device. The optical disc device is then utilized to form the image on the label film.

The advantage and spirit of the invention may be understood by the following recitations together with the appended drawings.

### BRIEF DESCRIPTION OF THE APPENDED DRAWINGS

FIG. 1A is a sectional view showing a construction of a label device according to a first preferred embodiment of the invention.

FIG. 1B illustrates one embodiment showing a base attached to the bottom side of the label device by an adhesive.

FIG. 2 is a top view of the label device showing a plurality of marks formed on the substrate of the label device according to the first embodiment of the invention.

FIG. 3 illustrates the configuration of the label device in an optical disc device according to the first embodiment of the invention.

FIG. 4 is a top view of a label sheet including the label device according to the present invention.

### DETAILED DESCRIPTION OF THE INVENTION

The present invention relates to a label device for optical discs. The label device, according to the invention, is capable of being installed into an optical disc device to form an image thereon. The optical disc device includes a writing unit for irradiating a laser beam on the label device to form the image.

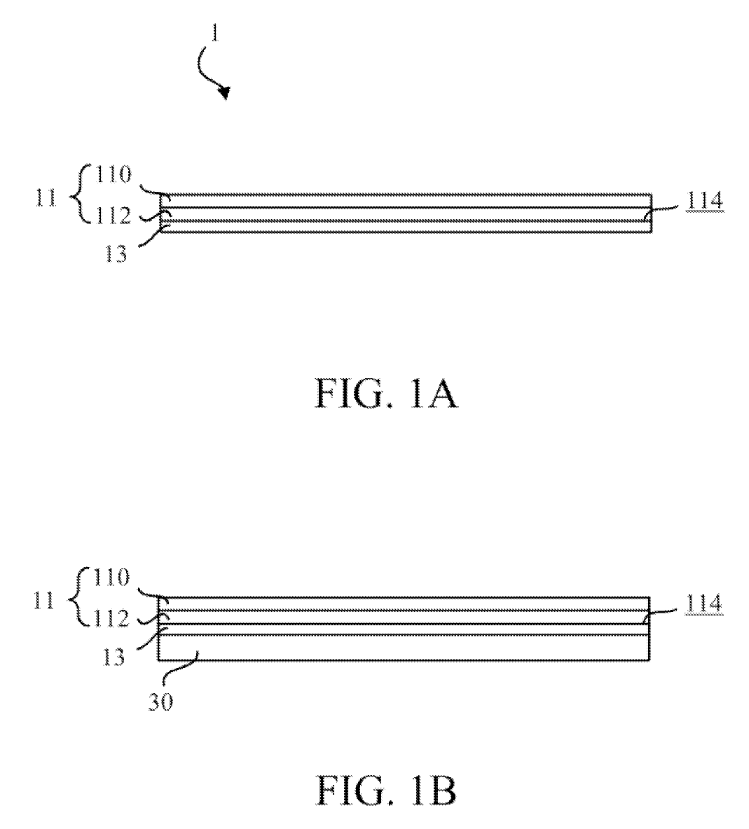

Referring to FIG. 1A, FIG. 1A is a sectional view showing a construction of a label device according to a first preferred embodiment of the invention. As shown in FIG. 1A, the label device 1 includes a label layer 11 and an adhesive 13. The label layer 11 has a bottom surface 114. The adhesive 13 is formed on the bottom surface 114 of the label layer 11. The label layer 11 is configured to form the image via the writing unit. The label layer 11 further includes a substrate 110 and a label film 112 for forming the image thereon. It should be noted that, as a point of reference, the thicknesses of the various components of label device 1 are greatly exaggerated in FIG. 1A for the purpose of illustration.

In one embodiment, the substrate 110 is formed adjacent to the bottom surface 114, and the label film 112 is formed on top of the substrate 110. Alternately, the label film 112 is formed adjacent to the bottom surface 114, and the substrate 110 is formed on top of the label film 112 in another embodiment. It should be noted that FIG. 1A only shows the latter case.

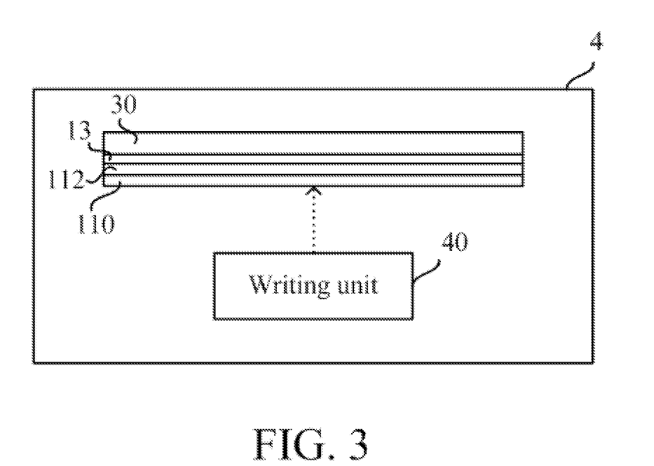

Please refer to FIG. 1B. In one embodiment, because the substrate 110 and the label film 112 are formed by very thin and flexible materials; a rigid disc-like base 30 is attached to the label device 1 by the adhesive 13 to support the label device 1. The label device 1 and the base 30 are sized to meet general-purpose optical discs; thus, it is acceptable by optical disc devices. Referring to FIG. 3, the base 30 in conjunction with the label device 1 are installed into an optical disc device 4 and are set with the label layer 11 facing the writing unit 40 of the optical disc device 4. The writing unit 40 irradiates a laser beam on the label film 112 of the label layer 11 to form the image. In one embodiment, the label device 1 can be detached from the base 30 to be further attached on a non-data side of an optical disc. In practical applications, the base 30 may be made of polycarbonate.

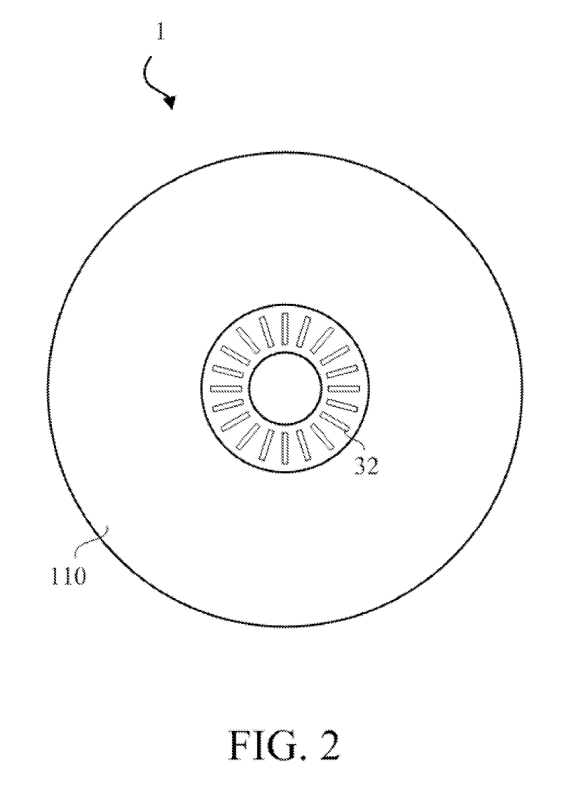

Referring to FIG. 2, FIG. 2 is a top view of the label device 1 according to the first embodiment of the invention. As shown in FIG. 2, a plurality of marks 32 are formed on the substrate 110 for assisting the writing unit 40 to position the image to be formed on the label film 112. Alternately, the marks 32 may also be formed on the base 30 in another embodiment.

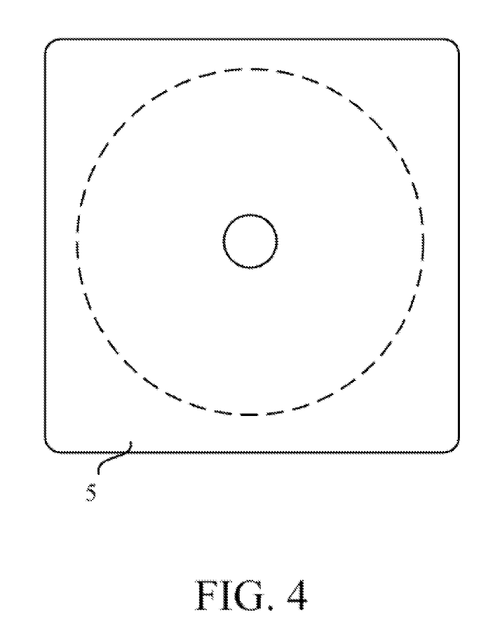

In one embodiment, the label device 1 may also be provided as part of a label sheet 5, one example of which is shown in FIG. 4. The label device 1 is defined on the label sheet 5 by a cut pattern (indicated by dashed lines in FIG. 4). The label sheet 5 may also be sized, such that a plurality of label devices 1 are provided. During use, the label device 1 is removed from the label sheet 5, and the bottom surface 114 of the label layer 11 is attached to a non-data side of an optical disc by the adhesive 13. The optical disc in conjunction with the label device 1 is installed into an optical disc device. The optical disc device is then utilized to form the image on the label film 112. As shown in FIG. 2, a plurality of marks 32 are formed on the substrate 110 for assisting the writing unit 40 to position the image to be formed on the label film 112. Alternately, the marks 32 may also be formed on the optical disc in another embodiment.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A label device capable of being installed into an optical disc device to form an image thereon, the optical disc device comprising a writing unit, said label device comprising:
a label layer having a bottom surface, the label layer being configured to form the image via the writing unit; and
an adhesive formed on the bottom surface of the label layer.

2. The label device of claim 1, wherein the label layer further comprises:
a substrate; and
a label film for forming the image thereon.

3. The label device of claim 2, wherein the substrate is formed adjacent to the bottom surface, and the label film is formed on top of the substrate.

4. The label device of claim 2, wherein the label film is formed adjacent to the bottom surface, and the substrate is formed on top of the label film.

5. The label device of claim 2, wherein a base is detachably attached to the bottom surface of the label layer by the adhesive, and the base in conjunction with the label device is then installed into the optical disc device to form the image on the label film by use of the optical disc device.

6. The label device of claim 1, wherein the label device is capable of being attached on a non-data side of an optical disc.

7. The label device of claim 6, wherein a plurality of marks are formed on the substrate for assisting the writing unit to position the image on the label film.

8. The label device of claim 6, wherein a plurality of marks are formed on the base for assisting the writing unit to position the image on the label film.

9. The label device of claim 2, wherein a non-data side of an optical disc is attached to the bottom surface of the label layer by the adhesive, and the optical disc in conjunction with the label device is then installed into the optical disc device to form the image on the label film by use of the optical disc device.

10. The label device of claim 9, wherein a plurality of marks are formed on the substrate for assisting the writing unit to position the image on the label film.

11. The label device of claim 9, wherein a plurality of marks are formed on the optical disc for assisting the writing unit to position the image on the label film.
